(19) United States
(12) Patent Application Publication
(10) Pub. No.: US 2007/0222909 A1
(43) Pub. Date: Sep. 27, 2007

(54) Flexible Flat Panel Displays

(75) Inventors: Peter Jan Slikkerveer, Eindhoven (NL); Jacob Marinus Jan Den Toonder, Eindhoven (NL); Nico Willard, Eindhoven (NL); Nigel David Young, Redhill (GB); Marinus Josephus Jakobus Dona, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,442

(22) PCT Filed: May 11, 2005
(86) PCT No.: PCT/IB05/51540

§ 371 Date: Nov. 21, 2006

(30) Foreign Application Priority Data
May 28, 2004 (EP) 04102412.6

(51) Int. Cl. G02F 1/1333

(52) U.S. Cl. 349/56; 29/592.1; 428/1.1

(57) ABSTRACT

A flexible flat panel display which exhibits fabric-like behavior, comprising a substrate (10) formed of an elastomeric material, preferably with a layer of textile material (14) embedded therein. The substrate (10) is arranged and configured so as to have a modulus of elasticity such that the display can be curved over at least two radii of curvature simultaneously and/or stretched in one or more directions under normal working conditions. The resultant display can be incorporated into, for example, clothing and the like. A method of manufacturing a flexible flat panel display is also described.

This invention relates generally to flexible flat panel displays, such as liquid crystal displays (LCD), and organic light emitting diode display, a field emitting display, or a thin or thick film electro-chrome or electro-luminescence display, and more particularly, to a flexible flat panel display which displays a fabric-like behavior. The invention further relates to a method of manufacturing a flexible flat panel display and to a flexible substrate for a flat panel display.

Flexible flat panel displays are at present in their development stages. However, an expanding market is envisaged in a wide variety of circumstances, where the flexible flat panel displays, in particular, experience tensile, compressive and shear stresses while the functionality of the flat panel display is maintained. During manufacturing of flat panel displays, they are exposed to pressure loads, for example, during bonding of layers together, and during bending and touching the display. However, the flexibility of the flat panel displays ensures that the largest possible number of flat panel displays will work.

A flexible flat panel display has been described in earlier patent applications. For example, British Patent Application No. GB2337131A describes a LCD and a manufacturing method for such, in which the LCD comprises two layers of substrates separated by wall-shaped spacers. The LCD is specifically designed so as to satisfy the condition qL⁴/Eh³≦π⁵V/48, where ‘q’ is the applied pressure, such as bonding pressure, during manufacturing, ‘L’ is the distance between the wall-shaped spacers, ‘E’ is the modulus of elasticity of the substrate, ‘h’ is the thickness of the substrate, ‘V’ is the tolerable change in the thickness of the cell defined between the two layers of substrates and the wall-shaped spacers. The above condition in respect of an LCD according to the above-mentioned British patent application is satisfied by manufacturing an LCD element which is capable of maintaining an even cell thickness (gap) during pressure applied normal to the substrate surface and providing a favorable display.

Furthermore, International Patent Application No. WO 02/43032 describes a flexible display device including a flexible substrate and a plurality of row and column electrodes attached to the substrate with a display material between the row electrodes and the column electrodes. The material for the substrate may be an inorganic glass or a polymer film. However, the flexible display device described in the above-mentioned International patent application utilizes amorphous and/or semi-crystalline polymers, which are in their glass state during normal working conditions of the display.

In fact, liquid crystal displays are commonly made on glass substrates and, although plastic displays use polymer-based substrates, they are made in a similar manner, starting from the substrate. Most (although not all) plastic substrates do allow making lightweight, unbreakable, flexible displays, but these displays still behave in a paper-like manner because curvature is only possible over a single radius, which makes this type of display unsuitable for use in clothing garments, for example.

Thus, it is an object of the present invention to provide a flexible panel display which exhibits fabric-like behavior, i.e. wherein stretching in a “warp” and “welt” direction is limited to a few percent and stretching in a direction diagonal to the “warp” and “welt” directions is limited to the order of tens of percent. It is also an object of the present invention to provide a method of manufacturing such a flexible flat panel display, and a flexible substrate for use in such a flat panel display.

In accordance with the present invention, there is provided a flexible flat panel display, comprising a first substrate which is at least partially formed of a composite material comprising an elastomeric material and a fibrous and/or particulate material for limiting the elasticity of said elastomeric material.

Thus, the present invention provides a passive flexible flat panel display which behaves like fabric in that it can be curved over at least two radii of curvature over two radii simultaneously (i.e. to allow, for example, spherical deformations or deformation into a saddle-like shape) and/or stretched in at least some directions to make it possible for the display to be well integrated into clothing garments and the like, thereby providing a breakthrough in wearable electronics and the like. Of course, it will be appreciated that the display can be simple indicator (i.e. low resolution or segmented) or a higher resolution display as required by the application.

The composite material may comprise an elastomeric material and a textile material. The textile material may be embedded within the elastomeric material and/or the textile material may be impregnated with elastomeric material. The elastomer may comprise any rubber or rubber-like polymer, for example, based on silicone, urethane, neoprene, butyl rubber, ethene-propene rubber, acrylate rubber, butadiene rubber, choloprene rubber, nitrile rubber, 1-1 propene rubber, fluoridised rubber, styrene-butadiene, natural rubber or any combination thereof. Suitable textile materials include, for example, natural textile fibers like wool and cotton, synthetic textile fibers like polyamide, polyester, viscose and acrylic, and technical fibers like glass, carbon and Dyneema (RTM), i.e. stretched polyethylene fibers, or co-polymers of mixtures of these fibers.

The first substrate may be fabricated from any polymer film in its rubber state during normal working conditions for a typical flat panel display. That is, a material having a glass transition temperature below the normal working conditions for a typical flat panel display e.g. below 80° C., below 60° C., below 40° C., below 30° C., below 0° C., below −20° C., below −40° C.

In an alternative embodiment, instead of the textile material referred to above, the elastomeric material could be reinforced with filler elements, such as beads or rods. In the case of rods, fibers or particles these could be arranged in one of many different ways, e.g. they could be aligned, random, overlapping, etc.

Also in accordance with the present invention, there is provided a method of manufacturing a flexible flat panel display, the method comprising providing a mould defining a required surface pattern of a substrate, creating at least one elastomeric substrate by a replication process comprising coating said mould with a liquid elastomeric material or pressing said mould into a softened elastomeric material, causing said elastomeric material to be solidified and then releasing it from said mould.

The method preferably further comprises creating two elastomeric substrates by said replication process and laminating said two elastomeric substrates together with an electro-optical display material therebetween.

The step of causing the elastomeric material to be solidified may comprise, for example, curing the elastomeric material, allowing it to cool or actively cooling it.

In the case where the substrate is formed of a composite material comprising an elastomeric material and a textile material, and the replication process comprises coating the mould with a liquid elastomeric material, the method may further comprise mounting a layer of textile material in the elastomeric material coated on said mould. Alternatively, the mould may be coated with a liquid resin and a layer of textile material may be pressed into the liquid resin layer. In either case, the textile material may be impregnated with an elastomeric material.

If the step of causing said elastomeric material to be solidified comprises curing, then the curing step may comprise thermal curing or curing using ultra-violet radiation, for example. The mould may comprise a base plate having thereon a patterned resist layer. In a preferred embodiment, a conductive layer and/or an alignment layer is provided on at least one of the substrates prior to laminating the two substrates together.

The electro-optical display material may comprise a liquid crystal, an electro-chrome or electro-phoretic element, a light emitting element, an organic or inorganic light emitting element, or any combination thereof. In fact, even a plasma may be used as the electro-optical medium.

The present invention extends still further to a flexible flat panel display manufactured in accordance with the method defined above.

Also in accordance with the present invention, there is provided a substrate for use in a flexible flat panel display, said substrate being formed of a composite material comprising a fibrous and/or particulate material and an elastomeric material.

The display is beneficially provided with conductive lines, and at least some of the fibers of said textile material are preferably directed substantially in the direction of the conductive lines. At least some of the fibers forming the textile material are beneficially conductive, in order to enhance the conductivity of the resultant conductive pattern.

Also in accordance with the present invention, there is provided a method of manufacturing a flexible substrate for use in a flexible flat panel display, the method comprising providing a mould defining a required surface pattern of said substrate, coating said mould with a liquid elastomeric material, causing said elastomeric material to be solidified and then releasing it from said mould.

These and other aspects of the present invention will be apparent from, and elucidated with reference to, the embodiments described herein.

Embodiments of the present invention will now be described by way of examples only and with reference to the accompanying drawings, in which:

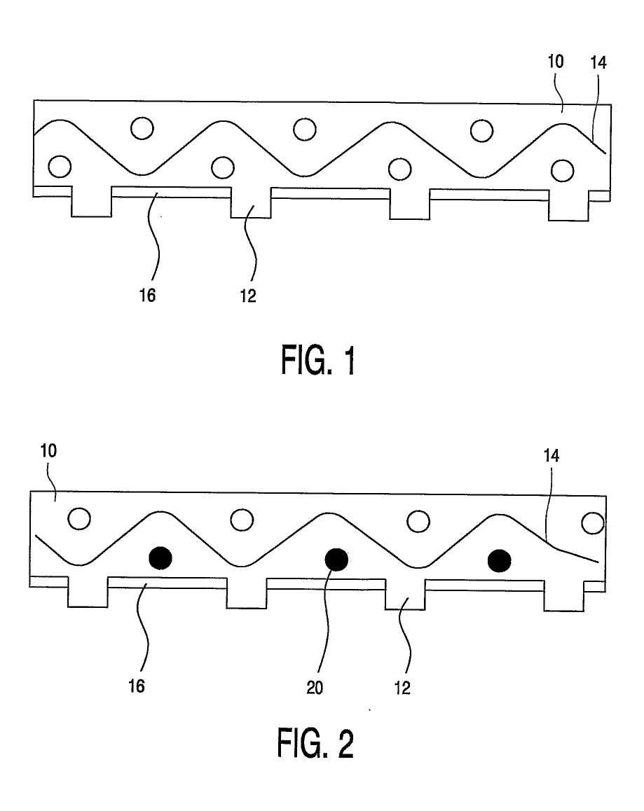

FIG. 1 is a schematic cross-sectional view of a substrate for use in a flexible flat panel display according to a first exemplary embodiment of the present invention;

FIG. 2 is a schematic cross-sectional view of a substrate for use in a flexible flat panel display according to a second exemplary embodiment of the present invention;

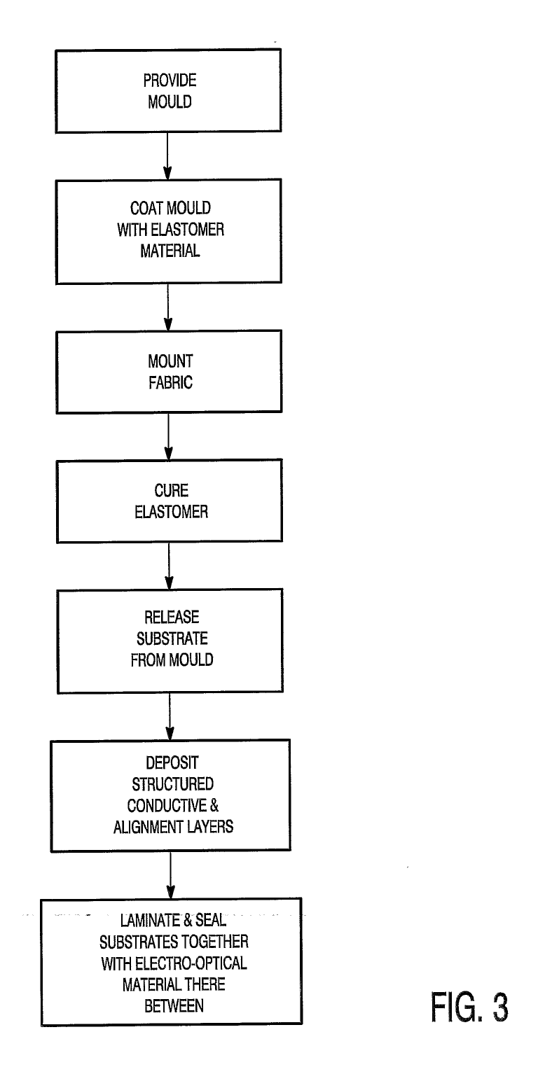

FIG. 3 is a schematic flow diagram illustrating the principle steps of a method of manufacturing a flat panel display according to an exemplary embodiment of the present invention;

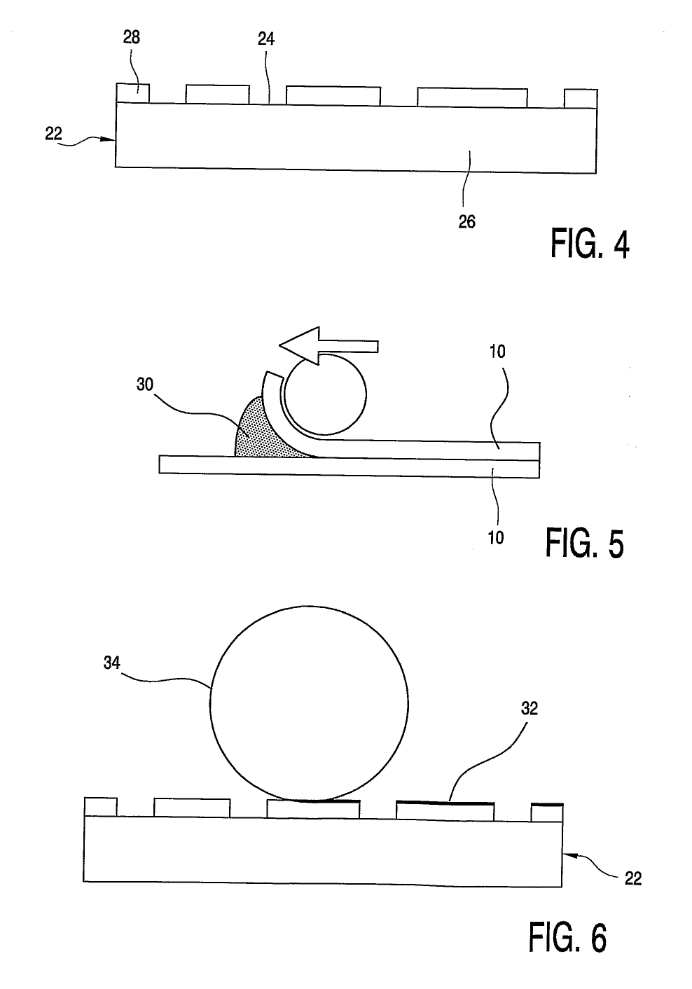

FIG. 4 is a schematic cross-sectional view of a mould for use in a method of manufacture according to an exemplary embodiment of the present invention;

FIG. 5 is a schematic diagram illustrating the step, in a method of manufacture according to an exemplary embodiment of the present invention, whereby two display substrates are laminated together with an electro-optical display material, such as liquid crystal (LC) therebetween, for cell assembly;

FIG. 6 is a schematic diagram illustrating the step of applying a conductive layer or an alignment layer to a display substrate by a contact printing process in a method of manufacturing a flexible flat panel display according to an exemplary embodiment of the present invention;

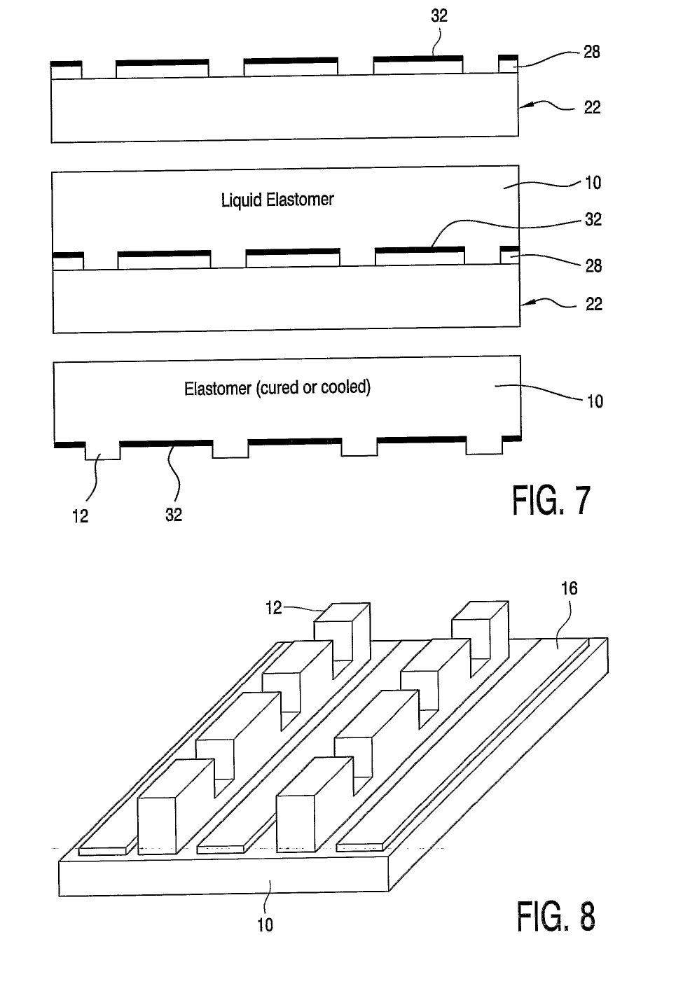

FIG. 7 illustrates schematically a replication process for use in a manufacturing method according to an exemplary embodiment of the present invention, with “on-mould” application of alignment and conductive layers; and

FIG. 8 is a schematic perspective diagram of a substrate according to an exemplary embodiment of the present invention including “swallow-tail” rib structures.

Thus, it is an object of the present invention to provide a flexible panel display which exhibits fabric-like behavior, as explained above, such that the display can be curved over at least two radii of curvature simultaneously, under normal working conditions.

U.S. Pat. No. 6,624,565 B2 describes an electro-optical display comprising a plurality of fibers, woven or knitted, some of the fibers including conductive wires. The fibers form a flexible carrying network with cells defined therebetween, and a layer of electro-optically active material fills the cells. A first conductive layer covers one side of the network, this layer being transparent or translucent and being in electrical contact with the conductive wires. A second conductive layer covers the other side of the network, but is insulated from the conductive wires. Although this document describes a electro-optical display which may, in principle, appear to behave like fabric, in practice it has two major disadvantages. Firstly, because it is emissive, it consumes a considerable amount of energy and the high drive voltage of the inorganic electroluminescent display principle used therein also makes it unsuitable for use in wearable clothing garments and the like.

International Patent Application No. PHNL021006EPP describes a flexible flat panel display in which the substrate is formed of a rubber or rubber-like material having a modulus of elasticity smaller than or equal to 1.5 Gpa, such that it is able to be bent into a low radius of curvature.

On the other hand, conventional liquid crystal displays and the like are commonly made on glass. The present invention proposes to make the substrates for a flat panel display from a composite elastomeric/fibrous and/or particulate material, instead of using glass.

Referring to FIG. 1 of the drawings, a single display substrate according to an exemplary embodiment of the present invention comprises an elastomeric body 10 provided with a plurality of wall-shaped spacers, wherein a textile (woven) fabric layer 14 is embedded in the elastomeric body 10 (optional). The textile fibers are beneficially directed in the direction of the conductive lines 16 of the display.

There are several options for the incorporation of fabric in the elastomer:

The fabric or fibers could be incorporated in both the front and back display substrates. In the case of uni-directional fibers, these are preferably aligned in the same direction as the conductive lines of the same substrate.

When the fabric or fibers are applied in the front substrate, the fibers should beneficially be very thin (<100 nm) or have substantially the same refractive index as the elastomeric substrate material.

For a reflective display (e.g. CTLC, electrophoretic or electrochrome), a non-transparent fabric could be incorporated in the back substrate.

In an alternative embodiment, instead of the textile material referred to above, the elastomeric material could be reinforced with filler elements, such as beads or rods. In the case of rods, these could be arranged in one of many different ways, e.g. they could be aligned, random, overlapping. In fact, it will be appreciated that the fibrous and/or particulate material may be arranged in one of many different ways, e.g. aligned, random, overlapping, etc.

It will be appreciated that the textile material referred to above is, in some exemplary embodiments of the present invention, optional. Without the incorporation of the textile material or fabric, the substrate can be made stretchable in all directions (in fact, some elastomers allow for 400% elongation). This superelasticity, however, has the disadvantage that it may give rise to problems in maintaining a cavity for the display effect and/or with the integrity/conductivity of the electrode patterns. Thus, the incorporation of a fibrous and/or particulate material has the effect of reducing this superelasticity to magnitudes more natural to the fabric itself; i.e. stretching in the directions of warp and weft is reduced to a few percent, whereas the shear motion (stretching in the diagonal of warp and weft is reduced to tens of percent). Aligning the warp and weft with the directions of the electrode patterns is preferred, in order to reduce the strain on these electrodes and also to alleviate potential problems with integrity and conductivity.

Thus, by aligning the electrode patterns in a matrix display with the weave of the textile layer 14, the electrode patterns may be used to assist the conduction in the conductive patterns 16 by incorporating thin, conductive fibers 20 in the substrate 10 that contact the conductive patterns 16 at certain positions, as illustrated schematically in FIG. 2 of the drawings.

A method of manufacturing a flat panel display according to an exemplary embodiment of the present invention will now be described, with reference to FIG. 3 of the drawings. One aspect of the present invention proposes the use of a replication process for the creation of the display substrates. Conventional soft lithographic techniques for fabricating micro- and nano-structures, rely on the replication of a patterned elastomeric stamp made from a master that can be inked with a mono-layer forming ink. The stamp is then used to print a pattern in a known micro-contact printing process. It has been shown that very high accuracy can be obtained in soft lithography using such replication techniques.

Thus, in a similar manner, in a replication process employed in a method of manufacture according to an exemplary embodiment of the present invention, a liquid elastomer may be coated on a mould 22 that contains depressions 24 where spacers are required in the final display, as shown schematically in FIG. 4 of the drawings. Thus, a simple mould 22 may comprise a base plate 26 made of a rigid material such as metal or glass, which base plate 26 is provided with a patterned resist layer 28 defining the above-mentioned depressions 24. The patterned resist layer may be created using any known technique, such as lithography, in order to obtain the desired structures. It will be appreciated that more complex structures can be produced by using multiple layers of resist or by etching or engraving (e.g. by electron beam), for example.

A piece of fabric 14, pre-impregnated with elastomer, may be mounted within the elastomer coating. Alternatively, the mould 22 could be coated with liquid resin and the fabric may then be pressed inside this wet layer. In either case, after curing the elastomer (thermally or by UV), the formed substrate 10 is released from the mould 22. This replication process can be executed with the same high precision as that illustrated in the field of micro-contact printing and may also be used to allow replicating spacers and/or alignment structures for liquid crystal molecules.

It will be further appreciated that the techniques referred to above for making the mould 22 are simply examples and other techniques will be apparent to a person skilled in the art. For example, the mould could be etched in a polymer, metal or dielectric film so as to optimize factors such as pattern resolution, steepness of mould edge, adhesion/release, bubble formation etc. The mould could also be electrochemically replicated to a metal (e.g. nickel) mould, to give a mould with significant durability.

After replication of the display substrate 10, a structured conductive layer, as well as an alignment layer is deposited on the substrate. In conventional liquid crystal displays, the conductive material used to create the conductive layer is ITO (indium tin oxide), but in the case of the present invention, this material is not ideal because it is an object of the invention to provide a display which permits relatively large deformations thereof, whereas the use of ITO would limit the amount of possible deformation of the display to less than 1%, as this is the critical strain for fracture of ITO films. It is therefore proposed to use an organic conductive material instead, such as PEDOT or PANI, which allow for much larger deformations.

There are several possible ways of making the conductive lines 16. For example, they may be applied by inkjet printing. Other possible methods rely on fabricating spacers with a special geometry and/or the use of surface modification, as described in the applicant's co-pending application no. PHNL030393EPP. The alignment layer could, for example, be spincoated or sprayed.

The display cells are then assembled by laminating two display substrates 10 together, their line patterns being perpendicular to one another, with, for example, liquid crystal 30 therebetween, as shown in FIG. 5 of the drawings.

In order to seal the structure, there are a number of options, which may be used in combination. For example, a sealing material could be used that is comparable to that of the substrate. Since the glue or the solvent in the glue will give rise to swelling of the substrate, it will provide good adhesion. For some rubbers (e.g. the thermoplastic elastomers), hot sealing (or welding) is an alternative option.

In yet another embodiment, a resin might be dissolved in the electro-optical layer 30 (e.g. liquid crystal, electrolyte, electrophoretic liquid), which resin may be selected such that, at UV exposure, it reacts and adheres the two substrates 10 together (see also stratifying LCD).

In another exemplary embodiment of the invention, the organic conductor might be coated on top of the mould 22, following which the elastomeric resin may be applied. Thus, during release of the elastomeric substrate from the mould, the conductors are now transferred to the newly-made substrate. The alignment layer or the conductive layer 32 may be applied to the mould 22 by means of a contact printing process in which a roller 34 having a coating thereon of the alignment or conductive layer material is brought into contact with the patterned resist layer 28 of the mould 22, as illustrated schematically in FIG. 6.

Following the contact printing process referred to above, and referring to FIG. 7 of the drawings, the mould 22 is then coated with a liquid elastomer and, once solidified by cooling or curing, the elastomer substrate 10 is released from the mould, the conductive layer 34 having been transferred thereto, as shown.

In order to prevent flow inside the display, the spacer structures 12 are preferably made in such a way that they enclose the total pixel, as shown in FIG. 8, where a rib spacer structure 12 with “swallowtails” is illustrated, with conductive lines 16 therebetween.

Thus, the exemplary embodiments of the present invention, as described above, provide a fabric-like display which can be integrated into, for example, clothing and the like. The resultant display is extremely durable and may even be made washable. The method of manufacturing the display is relatively very simple, and the fields of application of the present invention include displays (wearable, portable), indicators (wearable), sportswear, professional uniforms, textiles and fashion.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A flexible flat panel display, comprising a first substrate (10) which is at least partially formed of a composite material comprising an elastomeric material and a fibrous and/or particulate material for limiting the elasticity of said elastomeric material.

2. A display according to claim 1, wherein said composite material comprises an elastomeric material and a textile material (14).

3. A display according to claim 2, comprising conductive lines, wherein at least some of the fibers of said textile material (14) are directed substantially in the direction of the conductive lines.

4. A display according to claim 2, wherein at least some of the fibers forming the textile material (14) are conductive.

5. A display according to claim 1, wherein the fibrous and/or particulate material (14) is embedded within the elastomeric material.

6. A display according to claim 1, wherein the fibrous and/or particulate material (14) is impregnated with elastomeric material.

7. A display according to claim 1, wherein the elastomeric material comprises a rubber or rubber-like polymer, based on one or more of silicone, urethane, neoprene, butyl rubber, ethene-propene rubber, acrylate rubber, butadiene rubber, choloprene rubber, nitrile rubber, 1-1 propene rubber, fluoridised rubber, styrene-butadiene, natural rubber or any combination thereof.

8. A display according to claim 1, wherein said first substrate (10) is formed of a composite material comprising an elastomeric material reinforced with filler elements.

9. A display according to claim 1, wherein said substrates (10) comprise a ribbed spacer structure.

10. A display according to claim 9, wherein said spacer structure is arranged and configured to enclose substantially a complete pixel.

11. A method of manufacturing a flexible flat panel display, the method comprising providing a mould (22) defining a required surface pattern of a substrate (10), creating at least one elastomeric substrates (10) by a replication process comprising coating said mould (22) with a liquid elastomeric material or pressing said mould into a softened elastomeric material, causing said elastomeric material to be solidified and then releasing it from said mould (22).

12. A method according to claim 12, comprising creating two elastomeric substrates (10) by said replication process and laminating said two elastomeric substrates together with an electro-optical display material (30) therebetween.

13. A method according to claim 11, wherein the step of causing the elastomeric material to be solidified comprises one or more of curing the elastomeric material, allowing it to cool or actively cooling it.

14. A method according to claim 11, comprising mounting or pressing fibrous or particulate material (14) in or on said liquid or softened elastomeric material.

15. A method according to claim 14, comprising mounting or pressing a layer of textile material (14) in or on said liquid or softened elastomeric material.

16. A method according to claim 14, wherein the textile material (14) is impregnated with an elastomeric material.

17. A method according to claim 11, wherein the step of causing said elastomeric material to be solidified comprises thermal curing or curing using ultra-violet radiation.

18. A method according to claim 11, wherein the mould comprises a base plate (26) having thereon a patterned resist layer (28).

19. A method according to claim 12, wherein a conductive layer (34) and/or an alignment layer is provided on at least one of the substrates (10) prior to laminating the two substrates (10) together.

20. A method according to claim 19, wherein said replication process comprises applying a conductive pattern and/or alignment layer to said mould (22), coating said mould (22) with a liquid elastomeric material or pressing said mould (22) into a softened elastomeric material, causing said elastomeric material to be solidified and then releasing it and said conductive pattern and/or alignment layer from said mould (22).

21. A method according to claim 12, wherein the electro-optical display material comprises a liquid crystal, an electro-chrome or electro-phoretic element, a light emitting element, an organic or inorganic light emitting element, a polymer light emitting element, a plasma, or any combination thereof.

22. A method according to claim 11, wherein alignment structures and/or spacers are created on said substrate (10) by means of said replication process.

23. A flexible flat panel display manufactured in accordance with a method according to claim 12.

24. A garment incorporating a flexible flat panel display according to claim 1.

25. A substrate (10) for use in a flexible flat panel display, said substrate (10) being formed of a composite material comprising a fibrous and/or particulate material (14) and a elastomeric material.

26. A method of manufacturing a flexible substrate (10) for use in a flexible flat panel display, the method comprising providing a mould (22) defining a required surface pattern of said substrate (10), coating said mould with a liquid elastomeric material or pressing said mould (22) into a softened elastomeric material, causing said elastomeric material to be solidified and then releasing it from said mould (22).
